(19) United States
(12) Patent Application Publication
(10) Pub. No.: US 2011/0219384 A1
(43) Pub. Date: Sep. 8, 2011

(54) DYNAMIC LISTENER LOOKUP AND IMPLEMENTATION

(75) Inventors: Michael Charles Clark, Provo, UT (US); Jason Edward Rose, Spanish Fork, UT (US); Cara Lee Black, East Springville, UT (US)

(73) Assignee: HIT CONCEPTS LLC, Provo, UT (US)

(21) Appl. No.: 12/718,741

(22) Filed: Mar. 5, 2010

(51) Int. Cl. G06F 9/46; G06F 17/30; G06F 3/00

(52) U.S. Cl. 719/318

(57) ABSTRACT

Embodiments are directed to dynamically determining event listeners. A computer system sends a query to a data store to determine which event listeners are configured to listen for an indicated event. The event listeners are registered in the data store without the software module having to explicitly declare its event listeners. The computer system receives from the data store an indication of those event listeners that are configured to listen for the event. The computer system also sends the event to those event listeners indicated by the data store as being registered to receive notification of the event's occurrence.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In many cases, software applications are designed to allow interaction with a user. Such applications are often designed using the Model-View-Controller paradigm. In this paradigm, a software application's design logic (model) is separated from the application's presentation (view) and the management of any user interactions with the application (controller). Thus, a software developer can write software directed to each portion separately. This allows for modularity in the software as a developer can write modules specific to each area (model, view and controller).

### BRIEF SUMMARY

Embodiments described herein are directed to dynamically determining event listeners. In one embodiment, a computer system sends a query to a data store to determine which event listeners are configured to listen for an indicated event. The event listeners are registered in the data store without the software module having to explicitly declare its event listeners. The computer system receives from the data store an indication of those event listeners that are configured to listen for the event. The computer system also sends the event to those event listeners indicated by the data store as being registered to receive notification of the event's occurrence.

In another embodiment, a computer system provides dynamically determined event listeners to a software module. The computer system inserts into a database information identifying various event listeners that are configured to listen for events related to an identified software module. The computer system receives an event trigger at a software application indicating that an event related to the identified software module has occurred. The computer system queries the database to determine which listeners are configured to listen for events related to the identified software module. The computer system also receives from the database an indication of those listeners which are configured to listen for events related to the identified software module and sends the triggered event to those event listeners indicated as being related to the identified software module.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including dynamically determining event listeners.

FIG. 2 illustrates a flowchart of an example method for dynamically determining event listeners.

FIG. 3 illustrates a flowchart of an example method for providing dynamically determined event listeners to a software module.

FIG. 4 illustrates an alternate computer architecture in which embodiments of the present invention may operate.

### DETAILED DESCRIPTION

Embodiments described herein are directed to dynamically determining event listeners. In one embodiment, a computer system sends a query to a data store to determine which event listeners are configured to listen for an indicated event. The event listeners are registered in the data store without the software module having to explicitly declare its event listeners. The computer system receives from the data store an indication of those event listeners that are configured to listen for the event. The computer system also sends the event to those event listeners indicated by the data store as being registered to receive notification of the event's occurrence.

In another embodiment, a computer system provides dynamically determined event listeners to a software module. The computer system inserts into a database information identifying various event listeners that are configured to listen for events related to an identified software module. The computer system receives an event trigger at a software application indicating that an event related to the identified software module has occurred. The computer system queries the database to determine which listeners are configured to listen for events related to the identified software module. The computer system also receives from the database an indication of those listeners which are configured to listen for events related to the identified software module and sends the triggered event to those event listeners indicated as being related to the identified software module.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions, computer program products and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

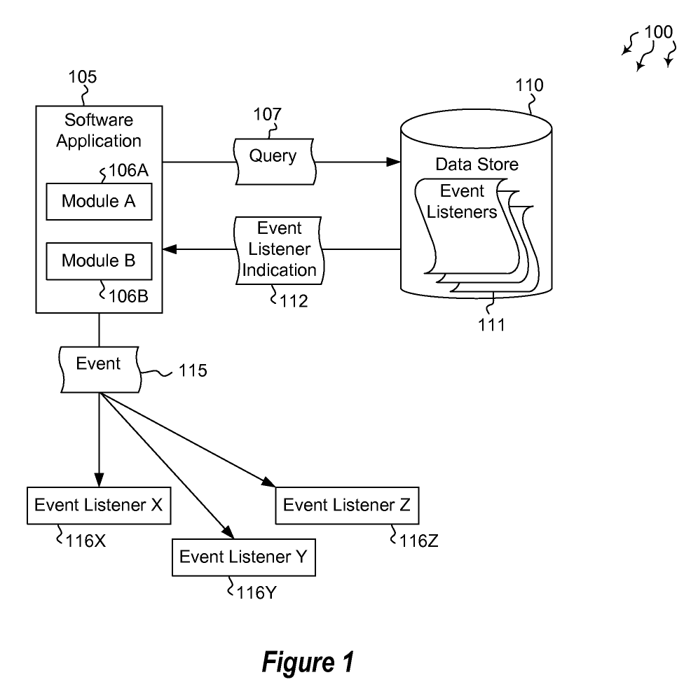

FIG. 1 illustrates a computer architecture 100 in which the principles of the present invention may be employed. Computer architecture 100 includes software application 105. Software application 105 may include any type of software application or software functionality. Software application 105 may include any number of software modules such as modules 106A and 106B. It will be understood that while two modules are illustrated in FIG. 1, any number of modules may be included in application 105. In some cases, software modules 106A and 106B may include various features and components. For instance, software application 105 may comprise a web application, module 106A may be include blogging functionality, module 106B may include forum functionality and the features and components may include items such as commenting, rating, searching, categorizing or tagging functionality. This is just one example among many and is included merely to illustrate the hierarchy among applications, modules and components/features.

Architecture 100 also includes data store 110. Data store 110 may include any type of data store including a database, a configuration file, a networked storage system or any other data storage from which data can be retrieved. In some embodiments, data store 110 may comprises a database which allows data to be retrieved using queries. For instance, software application 105 may send a query 107 to data store 110 requesting information. The requested information may include which event listeners correspond to or are listening for a certain event. As used herein, the term “listener” or “event listener” refers to a function which is called when a triggering event or condition occurs. Thus, when a listener is said to be “listening” for an event or condition, the listener is waiting for the event or condition to occur. Then, upon occurrence of the event or condition, the listener (i.e. the function listening for the event) is called. The called function then performs its programmed functionality.

As explained above, when an event occurs (or in some cases, even before an event occurs), a software application that does not have it's listeners (i.e. its listening functions) already preprogrammed (i.e. listed in the source code) may want to know to which listeners it is to send the event. Accordingly, query 107 may request this information, data store 110 will identify which event listeners 111 are related to a given event and send information indicating the identified event listeners in event listener indication 112.

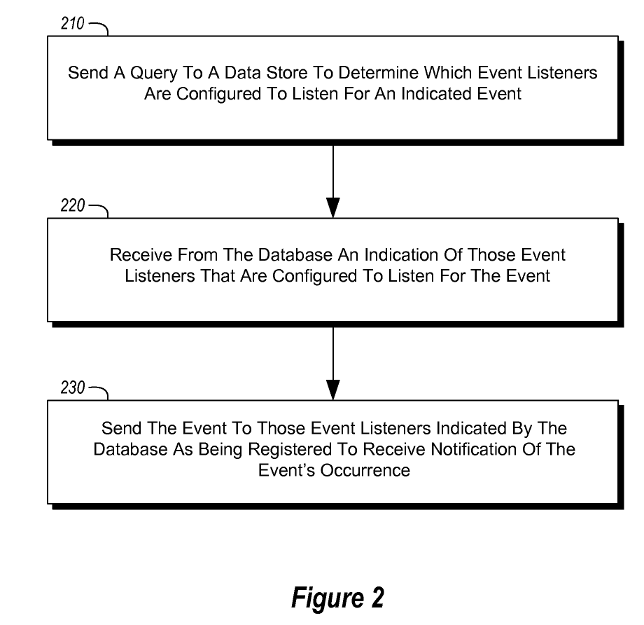

Accordingly, software application 105 may receive indication 112 and, based on the information identifying the appropriate event listeners, may send the event 115 to those identified listeners (e.g. event listeners X, Y and Z (116X, 116Y and 116Z), as shown in FIG. 1). It will be understood that event 115 may be sent to substantially any number of event listeners. It should also be noted that, as used herein, the term “event” may refer to a function call, the initiation of a software application or software module or any other action on which other modules may be dependent or to which they may be listening. These concepts will be explained in greater detail below with regard to method 200 of FIG. 2.

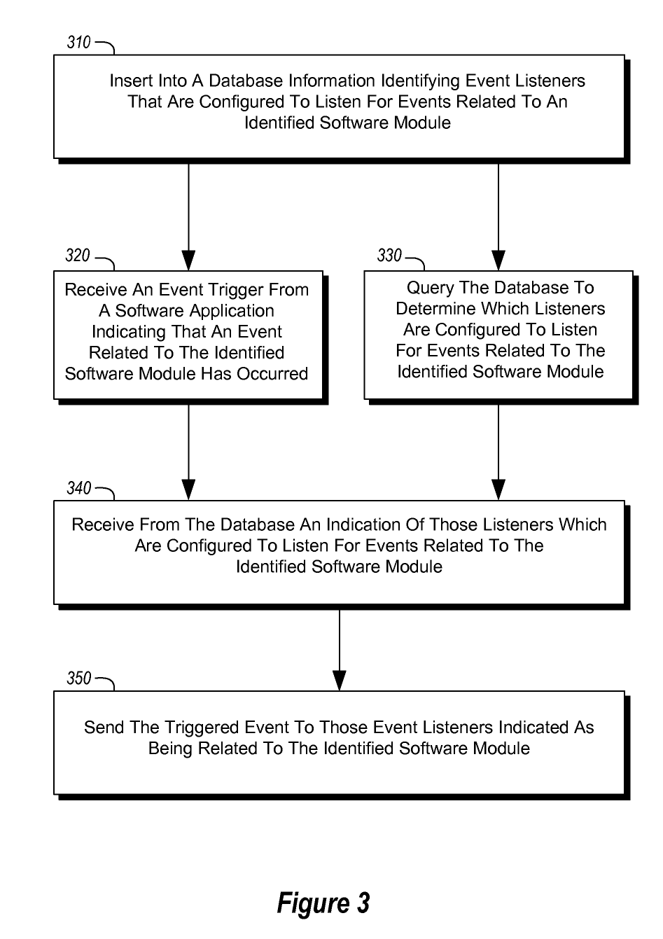

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for dynamically determining event listeners. The method 200 will now be described with frequent reference to the components and data of environment 100.

Method 200 includes an act of sending a query to a data store to determine which event listeners are configured to listen for an indicated event, wherein the event listeners are registered in the data store without the software module having to explicitly declare its event listeners (act 210). For example, software application 105 may send query 107 to data store 110 to determine which event listeners 111 are configured to listen for an indicated event (regardless of whether that event has occurred or not). The event listeners are registered in (asynchronous) data store 110 so that the software application or software module or software component does not have to explicitly declare its event listeners. Accordingly, a software module or component may be completely unaware what listeners are configured to listen for its various events This frees the software developer from having to hard code each event's listeners beforehand.

In some embodiments, some of the registered event listeners can be used with any software object. For instance, when an event listener is stored with a data store, the data store will store information indicating which events the listeners are to listen for. In this manner, the listeners are tied to events of a certain module. By generalizing the stored event listener information, the event listeners may be configured to work with (and listen for events for) other software modules. Accordingly, if, for example, if a user wanted to incorporate module B (106B) into another software module (e.g. module A (106A), the user could query the database to determine the event listeners for module A. Because module A's event listeners are registered and are stored in a separate location (i.e. not hard coded into module A's code), module B can use information regarding module A's event listeners to incorporate itself into module A without module A even knowing it.

Thus, continuing this example, if module A provided blogging functionality and module B provided commenting functionality, the commenting functionality of module B may be incorporated into the blog of module A without the blog being aware of the commenting functionality's presence. This works because the blog can keep firing (or not firing) events as it normally would. The commenting portion of module B (or the developer of module B) can work within module A by telling the database which of module A's events to listen for and implement them or react to them as the module or developer deems fit. It should also be noted that these generic event listeners can be implemented as part of another software module's (e.g. module B's) execution. This allows software modules to implement other software components without providing module-specific code support In some cases, data store 110 may be configured to store event listeners for multiple different software modules in a master configuration file stored in the data store. Such a configuration file may comprise an extensible markup language (XML) file or any other suitable file type.

In some cases, a master configuration file (or simply, configuration file) may include a value for each listener which allows data to be passed between the multiple different listeners. For instance, if one software module is implementing another one, the different values for the various listener (for each implanting software module) may identify to the corresponding software modules what data is being passed. Thus, the values may uniquely identify the data, but not necessarily the module from which the data came. This allows communication between modules without the modules knowing what the other module is or does.

For example, a five-star ratings module may be implemented in a forums module. Each of the modules may have various listeners configured to listen for a triggering event. The data that the forums module passes down to its view may come in the form of a variable (e.g. “forumList”) which is a data object. This data object may include forum identifiers, titles, threads, and other elements to be used in its respective view file. In this configuration, to pass data from the ratings module to the forums module, the variable value may simply include the word “forumList”. Then, the ratings module would be able to have a copy of the data included with the “forumList” object, so that it may pull out the referenced IDs and be able to show the ratings for each forum on the list, without ever knowing that it's communicating with the forums module (as opposed to another module such as blogs or videos).

Following the model-view-controller (MVC) paradigm described above, changes to a software module's execution may result in changes to the module's view. Accordingly, in some embodiments, software application 105's corresponding view may be dynamically updated based on any changes made to its execution. This will similarly occur when changes are made to any of application 105's software modules or subfeatures. In some cases, a view comprising the output generated by a given software module is parsed by an application or computer system. The parsed view is then loaded by the computer system, whereupon one or more software components may be injected into the loaded view. These injected software components may be configured to operate independent of (although be shown within) the existing software modules. The injecting may include multiple different forms including the following: prepending, appending, before, after and wrapping. In some cases, the injected software components may be injected into the document object model (DOM) of a corresponding web page.

Returning to FIG. 2, method 200 includes an act of receiving from the data store an indication of those event listeners that are configured to listen for the event (act 220). For example, software application 105 may receive from data store 110 indication 112 indicating those event listeners that are configured to listen for a given event. Data store 110 may be configured to store any number of event listeners corresponding to any number of software modules or applications. The data store may be included on a single computer system or may be spread over a plurality of computer systems networked together via a local area network, wide area network or the interne.

Method 200 also includes an act of sending the event to those event listeners indicated by the data store as being registered to receive notification of the event's occurrence (act 230). For example, software application 105 may send event 115 to event listeners X, Y and Z (116X, 116Y and 116Z, respectively) in cases where those event listeners are indicated by data store 110 as being registered to receive notification when event 115 has occurred. In some embodiments, an access control mechanism may be implemented to limit when one or more of the listeners are triggered. Thus, for instance, in cases where a developer or other user wanted to limit the times when various listeners are initiated upon the occurrence of an event, an access control mechanism may be used to define which event listeners are ok to initiate. In some cases, each of the acts (210, 220 and 230) are performed recursively each time a software module is initiated. This ensures that each time a module is run, the most up-to-date indication of event listeners is used. The processing of acts 210-230 also ensures that the first time a module is run, the data store is checked for appropriate event listeners. As a user or developer may change the associated event listeners for any software module, feature or application, at substantially any time, checking the data store each time the module is started ensures that the latest indication of event listeners is used.

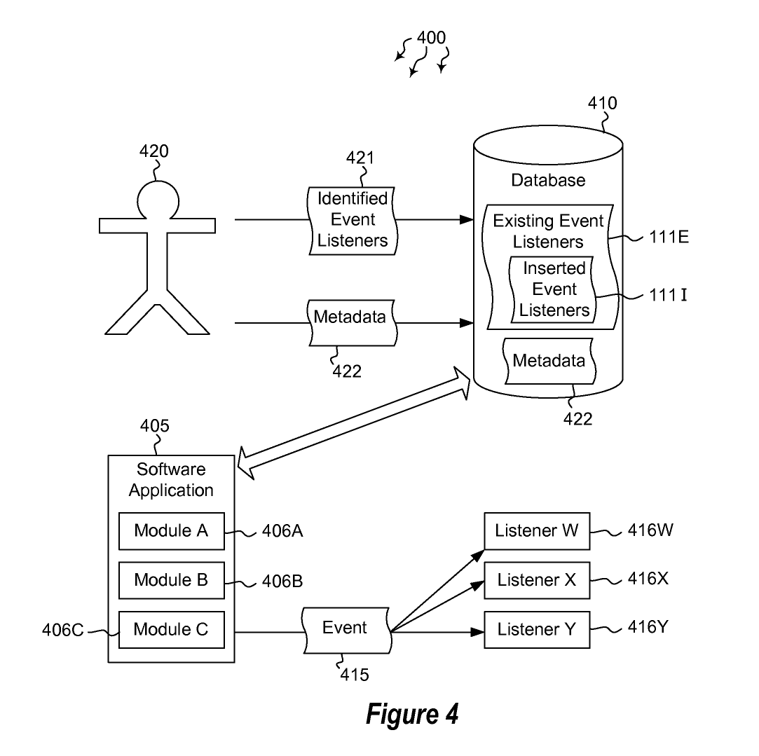

FIG. 3 illustrates a flowchart of a method 300 for providing dynamically determined event listeners to a software module. The method 300 will now be described with frequent reference to the components and data of environment 400 of FIG. 4.

Method 300 includes an act of inserting into a database information identifying one or more event listeners that are configured to listen for events related to an identified software module (act 310). For example, user 420 may insert into database 410 information (e.g. 421) identifying various event listeners that are configured to listen for events related to a given software module (e.g. module A 406A). User 420 may be any type of computer user including a developer, an administrator and, at least in some cases, an end user. The user may indicate the identified listeners directly or may configure a software application or module to send a list of identified event listeners 421 to the database. The inserted event listeners 111I may be inserted into the existing event listeners 111E stored in database 410.

In some cases, the information identifying one or more event listeners that are configured to listen for events related to an identified software module is stored in an XML configuration file. Such an XML configuration file can be continuously and dynamically updated with new indications of event listeners. Listeners may be registered before or after the initial occurrence of a triggering event. In some embodiments, a software module developer may register a portion of metadata identifying internal structure characteristics of the software module such that changes to the software module's internal structure are made according to the added metadata. Thus, the provided metadata may indicate characteristics of a software module that may assist a user in making changes to that module. In other cases, changes may be made to a software module simply based on the predictable nature of the software module. The added metadata 422, however, may assist in making the changes in a proper manner. These changes may be made transparently without the changed module knowing.

Method 300 includes an act of receiving an event trigger at a software application indicating that an event related to the identified software module has occurred (act 320). For example, software application 405 may receive an event trigger indicating that event 415 has occurred. Event 415 is then to be sent to those listeners that are configured to listen for the event. These event listeners may include either or both of existing event listeners 111E and inserted event listeners 111I stored in database 410. The database 410 may be queried by application 405 or any of software modules 406A, 406B or 406C to determine which listeners are configured to listen for the event.

Method 300 includes an act of the application querying the database to determine which listeners are configured to listen for events related to the identified software module (act 330). For example, software application 405 may query database 410 to determine which of existing event listeners 111E and inserted event listeners 111I are configured to listen for events related to the identified event. As mentioned above, the identified event may include any type of software event, function call, user input, software module initiation, network communication or other type of event.

Method 300 includes an act of receiving from the database an indication of those listeners which are configured to listen for events related to the identified software module (act 340). For example, software application 405 may receive from database 410 an indication of those listeners (from either or both of existing event listeners 111E and inserted event listeners 111I) are configured to listen for events related to the identified software module. Thus, because the event listeners for each software application, software module and software feature are stored in database 410, the database can be queried to determine which listeners are configured to listen for a given event. Moreover, because the event listeners for each software portion are stored in the database, the developers of the various software portions do not have to include an indication of which listeners are to listen for given events. Moreover, the developer does not have to worry about when the events are triggered, as long as the correct event listeners are identified in the data store.

Method 300 includes an act of sending the triggered event to those event listeners indicated as being related to the identified software module (act 350). For example, software application 405 may send triggered event 415 to those event listeners indicated as being related to the identified software module (e.g. as shown in FIG. 4, event listeners 416W, 416X and 416Y). In some cases, depending on which event is triggered and which event listeners are configured to listen for the event, the event may be selectively fired to only a single event listener (e.g. event listener 416Y) or to many event listeners other than those illustrated.

In this manner, event listeners may be stored in a data store and dynamically determined at any time, including before the occurrence of an event. The central, external storage of event listeners allows software modules or applications to incorporate other software modules with no knowledge of how the other modules have been programmed to work. Thus, as described herein, a determination of event listeners may be dynamically determined by querying a database instead of being hard coded into each software module.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, in a computer programming environment configured to implement an observer pattern, a computer-implemented method for dynamically determining event listeners, the method comprising:
an act of sending a query to a data store to determine which event listeners are configured to listen for an indicated event, wherein the event listeners are registered in the data store without the software module having to explicitly declare its event listeners;
an act of receiving from the data store an indication of those event listeners that are configured to listen for the event; and
an act of sending the event to those event listeners indicated by the data store as being registered to receive notification of the event's occurrence.

2. The method of claim 1, wherein at least one of the registered event listeners is rewritten in a generic manner such that the event listener can be applied to any software object.

3. The method of claim 2, further comprising an act of a second, different software module implementing the rewritten generic event listener as part of the second software module's execution.

4. The method of claim 3, further comprising an act of updating a software application's view based on any changes made to the second software module's execution.

5. The method of claim 3, wherein the rewritten generic event listener allows software modules to implement other software components without providing module-specific code support.

6. The method of claim 1, wherein a plurality of listeners for different software modules are registered in a master configuration file stored in the data store.

7. The method of claim 6, wherein the master configuration file includes a value for each listener which allows data to be passed between the plurality of listeners, the value identifying to the corresponding software modules what data is being passed.

8. The method of claim 1, further comprising an act of implementing an access control mechanism to limit when one or more of the listeners are triggered.

9. The method of claim 1, further comprising recursively performing each act of claim 1 each time the software module is initiated.

10. The method of claim 1, further comprising:
an act of parsing a view comprising at least the output generated by the software module;
an act of loading the parsed view; and
an act of injecting one or more software components into the loaded view.

11. The method of claim 10, wherein the injecting includes a plurality of forms including the following: prepending, appending, before, after and wrapping.

12. The method of claim 1, wherein the event comprises a user interaction with a graphical user interface corresponding to the software module.

13. The method of claim 1, wherein the event listeners are accessible through a plurality of different interfaces.

14. At a computer system including a processor and a memory, in a computer programming environment configured to implement an observer pattern, a computer-implemented method for providing dynamically determined event listeners to a software module, the method comprising:
an act of inserting into a database information identifying one or more event listeners that are configured to listen for events related to an identified software module;
an act of receiving an event trigger at a software application indicating that an event related to the identified software module has occurred;
an act of the application querying the database to determine which listeners are configured to listen for events related to the identified software module;
an act of receiving from the database an indication of those listeners which are configured to listen for events related to the identified software module; and
an act of sending the triggered event to those event listeners indicated as being related to the identified software module.

15. The method of claim 14, wherein the information identifying one or more event listeners that are configured to listen for events related to an identified software module is inserted into the database by a software module developer.

16. The method of claim 15, wherein the software module developer registers a portion of metadata identifying internal structure characteristics of the software module such that changes to the software module's internal structure are made according to the added metadata.

17. The method of claim 14, wherein the information identifying one or more event listeners that are configured to listen for events related to an identified software module is stored in an XML configuration file.

18. The method of claim 14, further comprising an act of the identified software module transparently modifying a second different module without notifying the second module of the modifications.

19. A computer program product for implementing a method for providing modular software functionality using generic callbacks managed in a data store, the computer program product comprising one or more computer-readable storage media having stored thereon computer-executable instructions that, when executed by one or more processors of the computing system, cause the computing system to perform the method, the method comprising:
an act of sending a query to a data store to determine which event listeners are configured to listen for an indicated event, wherein the event listeners are registered in the data store without the software module having to explicitly declare its event listeners;
an act of an act of receiving from the data store an indication of those event listeners that are configured to listen for the event; and
an act of sending the event to those event listeners indicated by the data store as being registered to receive notification of the event's occurrence.

20. The computer program product of claim 19, further comprising:
an act of parsing a view comprising at least the output generated by the software module;
an act of loading the parsed view; and
an act of injecting one or more software components into the loaded view.
